(19) United States
(12) Patent Application Publication
(10) Pub. No.: US 2013/0260131 A1
(43) Pub. Date: Oct. 3, 2013

(54) THERMOPLASTIC MOLDING PREFORM

(71) Applicants: Satoshi SEIKE, Decatur, AL (US); Makoto Kibayashi, Decatur, AL (US); Kishio Miwa, Decatur, AL (US); Anand Valliyur Rau, Decatur, AL (US); Leigh A. Hudson, Decatur, AL (US)

(72) Inventors: Satoshi SEIKE, Decatur, AL (US); Makoto Kibayashi, Decatur, AL (US); Kishio Miwa, Decatur, AL (US); Anand Valliyur Rau, Decatur, AL (US); Leigh A. Hudson, Decatur, AL (US)

(21) Appl. No.: 13/432,487

(22) Filed: Mar. 28, 2012

(51) Int. Cl. B32B 27/04

(52) U.S. Cl. 428/300.4

(57) ABSTRACT

A thermoplastic molding preform is made of a carbon fiber, which is coated with a sizing at an amount X between 0.05 and 0.30 weight %. The sizing is formed of a heat resistant polymer or a precursor of the heat resistant polymer. The amount X of the sizing is expressed with a following formula:

$$X = \frac{{W}_{0} - {W}_{1}}{{W}_{0}} \times 100$$

where W₀ is the weight of the carbon fiber with the sizing, and W₁ is the weight of the carbon fiber without the sizing.

### BACKGROUND OF THE INVENTION AND RELATED ART STATEMENT

The present invention relates to a thermoplastic molding preform containing a carbon fiber with a sizing capable of achieving good mechanical properties and high resistance against thermal degradation.

Carbon fiber reinforced thermoplastics (CFRTP), which have good mechanical properties such as high specific strength, high specific modulus, high impact strength and quick molding, are made of thermoplastic molding preforms. In recent years, research and development efforts in this area have been flourishing.

In general, polymer matrix composite materials tend to show reduced strength and modulus under high temperature conditions. Therefore, heat resistant matrix resins are necessary in order to maintain desired mechanical properties under high temperature conditions. Such heat resistant matrix resins include a thermoplastic polyimide resin, a polyamideimide resin, a polyetherimide resin, a polysulfone resin, a polyethersulfone resin, a polyetheretherketone resin, a polyetherketoneketone resin, a polyamide and a polyphenylenesulfide resin.

CFRTP with heat resistant matrix resins are molded under high temperature conditions, so the sizing must withstand thermal degradation. If the sizing undergoes thermal degradation, voids and some other problems occur inside a composite that result in reduced composite mechanical properties. Accordingly, a heat resistant sizing is an essential part of CFRP for good handleability, high interfacial strength, controlling fuzz development, etc.

U.S. Pat. No. 4,394,467 and U.S. Pat. No. 5,401,779 have disclosed a polyamic acid oligomer as an intermediate agent generated from a reaction of an aromatic diamine, an aromatic dianhydride, and an aromatic tetracarboxylic acid diester. When the intermediate agent is applied to a carbon fiber at an amount of 0.3 to 5 weight % (or more desirably 0.5 to 1.3 weight %), it is possible to produce a polyimide sizing. However, the sizing amount of 0.3 to 5 weight % does not seem efficient for good spreadability of carbon fibers related to resin impregnation, for fabrication of a tape with low void content and best mechanical properties.

U.S. Pat. No. 7,138,023 and U.S. Pat. No. 7,754,323 have disclosed a thermoplastic molding preform made of chopped carbon fiber and thermoplastic resin fiber for high temperature applications. But the sizing amount on the carbon fiber and the type of the sizing required to achieve good spreadability of the strand, high adhesion strength to thermoplastic matrix and thermal stability are not described.

In view of the problems described above, the object of the present invention is to provide a thermoplastic molding preform containing a carbon fiber with a thermally stable sizing that enables enhanced adhesion to the thermoplastic matrix, and a lower propensity for generation of voids during processing owing to the inherent thermal stability as compared with less stable sizings.

Further objects and advantages of the invention will be apparent from the following description of the invention.

### SUMMARY OF THE INVENTION

In order to attain the objects described above, according to the present invention, a thermoplastic molding preform is made of a carbon fiber coated with a sizing at an amount X between 0.05 and 0.30 weight %. The sizing is formed of a heat resistant polymer or a precursor of the heat resistant polymer. The amount X of the sizing is expressed as percentage by the following formula:

$$X = \frac{{W}_{0} - {W}_{1}}{{W}_{0}} \times 100$$

where W₀ is the weight of the carbon fiber with the sizing, and W₁ is the weight of the carbon fiber without the sizing.

### BRIEF DESCRIPTION OF THE DRAWINGS

FIG. 1 is a graph showing a relationship between strand tensile strength and sizing amount (ULTEM type polyetherimide, T700SC-12K);

FIG. 2 is a graph showing a relationship between drape value and sizing amount (ULTEM type polyetherimide, T700SC-12K);

FIG. 3 is a graph showing a relationship between rubbing fuzz and sizing amount (ULTEM type polyetherimide, T700SC-12K);

FIG. 4 is a graph showing a relationship between ILSS and sizing amount (ULTEM type polyetherimide, T700SC-12K);

FIG. 5 is a graph showing a TGA measurement result of T700S type fiber coated with ULTEM type polyetherimide;

FIG. 6 is a graph showing a TGA measurement result of ULTEM type polyetherimide;

FIG. 7 is a graph showing a relationship between strand tensile strength and sizing amount (KAPTON type polyimide, T800SC-24K, KAPTON is a registered trademark of E. I. du Pont de Nemours and Company);

FIG. 8 is a graph showing a relationship between drape value and sizing amount (KAPTON type polyimide, T800SC-24K);

FIG. 9 is a graph showing a relationship between rubbing fuzz and sizing amount (KAPTON type polyimide, T800SC-24K);

FIG. 10 is a graph showing a relationship between ILSS and sizing amount (KAPTON type polyimide, T800SC-24K);

FIG. 11 is a graph showing a TGA measurement result of T800S type fiber coated with KAPTON type polyimide;

FIG. 12 is a graph showing a TGA measurement result of KAPTON type polyimide;

FIG. 13 is a graph showing a relationship between strand tensile strength and sizing amount (ULTEM type polyetherimide, T800SC-24K, ULTEM is a registered trademark of Saudi Basic Industries Corporation);

FIG. 14 is a graph showing a relationship between drape value and sizing amount (ULTEM type polyetherimide, T800SC-24K);

FIG. 15 is a graph showing a relationship between rubbing fuzz and sizing amount (ULTEM type polyetherimide, T800SC-24K);

FIG. 16 is a graph showing a relationship between ILSS and sizing amount (ULTEM type polyetherimide, T800SC-24K);

FIG. 17 is a graph showing a relationship between strand tensile strength and sizing amount (Methylated melamine-formaldehyde, T700SC-12K);

FIG. 18 is a graph showing a relationship between drape value and sizing amount (Methylated melamine-formaldehyde, T700SC-12K);

FIG. 19 is a graph showing a relationship between rubbing fuzz and sizing amount (Methylated melamine-formaldehyde, T700SC-12K);

FIG. 20 is a graph showing a relationship between ILSS and sizing amount (Methylated melamine-formaldehyde, T700SC-12K);

FIG. 21 is a graph showing a TGA measurement result of T700S type fiber coated with methylated melamine-formaldehyde;

FIG. 22 is a graph showing a TGA measurement result of methylated melamine-formaldehyde;

FIG. 23 is a graph showing a relationship between strand tensile strength and sizing amount (Epoxy cresol novolac, T700SC-12K);

FIG. 24 is a graph showing a relationship between drape value and sizing amount (Epoxy cresol novolac, T700SC-12K);

FIG. 25 is a graph showing a relationship between rubbing fuzz and sizing amount (Epoxy cresol novolac, T700SC-12K);

FIG. 26 is a graph showing a relationship between ILSS and sizing amount (Epoxy cresol novolac, T700SC-12K);

FIG. 27 is a graph showing a TGA measurement result of T700S type fiber coated with epoxy cresol novolac;

FIG. 28 is a graph showing a TGA measurement result of epoxy cresol novolac;

FIG. 29 is a graph showing adhesion strength between a T800S type fiber and polyetherimide resin;

FIG. 30 is a graph showing adhesion strength between a T700S type fiber and polyetherimide resin;

FIG. 31 is a schematic view showing a measurement procedure of drape value;

FIG. 32 is a schematic view showing a measurement instrument of rubbing fuzz;

FIG. 33 is geometry of a dumbbell shaped specimen for Single Fiber Fragmentation Test;

Table 1 shows a relationship between strand tensile strength and sizing amount (ULTEM type polyetherimide, T700SC-12K);

Table 2 shows a relationship between drape value and sizing amount (ULTEM type polyetherimide, T700SC-12K);

Table 3 shows a relationship between rubbing fuzz and sizing amount (ULTEM type polyetherimide, T700SC-12K);

Table 4 shows a relationship between ILSS and sizing amount (ULTEM type polyetherimide, T700SC-12K);

Table 5 shows a relationship between strand tensile strength and sizing amount (KAPTON type polyimide, T800SC-24K);

Table 6 shows a relationship between drape value and sizing amount (KAPTON type polyimide, T800SC-24K);

Table 7 shows a relationship between rubbing fuzz and sizing amount (KAPTON type polyimide, T800SC-24K);

Table 8 shows a relationship between ILSS and sizing amount (KAPTON type polyimide, T800SC-24K);

Table 9 shows a relationship between strand tensile strength and sizing amount (ULTEM type polyetherimide, T800SC-24K);

Table 10 shows a relationship between drape value and sizing amount (ULTEM type polyetherimide, T800SC-24K);

Table 11 shows a relationship between rubbing fuzz and sizing amount (ULTEM type polyetherimide, T800SC-24K);

Table 12 shows a relationship between ILSS and sizing amount (ULTEM type polyetherimide, T800SC-24K);

Table 13 shows a relationship between strand tensile strength and sizing amount (Methylated melamine-formaldehyde, T700SC-12K);

Table 14 shows a relationship between drape value and sizing amount (Methylated melamine-formaldehyde, T700SC-12K);

Table 15 shows a relationship between rubbing fuzz and sizing amount (Methylated melamine-formaldehyde, T700SC-12K);

Table 16 shows a relationship between ILSS and sizing amount (Methylated melamine-formaldehyde, T700SC-12K);

Table 17 shows a relationship between strand tensile strength and sizing amount (Epoxy cresol novolac, T700SC-12K);

Table 18 shows a relationship between drape value and sizing amount (Epoxy cresol novolac, T700SC-12K);

Table 19 shows a relationship between rubbing fuzz and sizing amount (Epoxy cresol novolac, T700SC-12K);

Table 20 shows a relationship between ILSS and sizing amount (Epoxy cresol novolac, T700SC-12K);

Table 21 shows adhesion strength between a T800S type fiber and polyetherimide resin;

Table 22 shows adhesion strength between a T700S type fiber and polyetherimide resin; and

Table 23 shows tensile strength of polyphenylenesulfide composites

### DETAILED DESCRIPTION OF PREFERRED EMBODIMENTS

Embodiments of the present invention will be explained with reference to the accompanying drawings.

A thermoplastic molding preform described here is made of carbon fiber and thermoplastic resin fiber, which are distributed uniformly in a two-dimensional surface. The preforms can be stacked and thermoformed to obtain a thermoplastic semi-molded material and a thermoplastic molded material. A thermoplastic semi-molded material that is not fully impregnated with resin has a typical void content, by volume between 10 and 80%, in which the most of voids are interconnected throughout the material. The semi-molded material can be further molded to expel the voids and obtain a usable product. A thermoplastic molded material that is fully impregnated with resin has a typical void content, by volume of less than 10%, where the material may contain isolated voids. A composite (final product) can be obtained from the preform, the semi-molded material or the molded material.

The invention is not limited to any carbon fiber orientation in the preform. Isotropy or anisotropy could be applicable.

In the embodiment, the ideal carbon fiber ratio per the total volume of carbon fibers and resin fibers in the preform, the semi-molded material and the molded material is 10 to 70% by volume, with 20 to 60% by volume being preferred. The carbon fiber ratio should be greater than 10% by volume to achieve good mechanical properties. On the other hand, the carbon fiber content should be less than 70% by volume to prevent high void content, which reduces the mechanical properties of a composite.

The preferred carbon fiber areal weight in the thermoplastic molding preform is preferably 5 to 600 g/m². 10 to 300 g/m² are more preferable.

A commercially available carbon fiber is used (including graphite fiber). Specifically, a pitch type carbon fiber, a rayon type carbon fiber, or a PAN (polyacrylonitrile) type carbon fiber is used. Among these carbon fibers, the PAN type carbon fibers that have high tensile strength are the most desirable for the invention.

Among the carbon fibers, there are a twisted carbon fiber, an untwisted carbon fiber and a never twisted carbon fiber. The carbon fibers have preferably a yield of 0.06 to 4.0 g/m and a filament number of 1,000 to 48,000. In order to have high tensile strength and high tensile modulus in addition to low fuzz generation during the carbon fiber production, the single filament diameter should be within 3 μm to 20 μm, more ideally, 4 μm to 10 μm. The length of a carbon fiber is desirably 10 mm to 100 mm, with the optimum length being 20 mm to 80 mm.

Strand strength is desirably 3.0 GPa or above. 4.5 GPa or above is more desirable. 5.5 GPa or above is even more desirable. Tensile modulus is desirably 200 GPa or above. 220 GPa or above is more desirable. 240 GPa or above is even more desirable. If the strand strength and modulus of the carbon fiber are below 3.0 GPa and 200 GPa, respectively, it is difficult to obtain the desirable mechanical property when the carbon fiber is made into composite materials.

The desirable sizing amount on carbon fiber is between 0.05 and 0.30 weight %. Between 0.05 and 0.25 weight % is more desirable. Between 0.05 and 0.20 weight % is even more desirable. If the sizing amount is less than 0.05 weight %, when carbon fiber is produced, fuzz generation makes the smooth production more difficult. On the other hand if the sizing amount is above 0.30 weight %, the carbon fiber is almost completely coated by the heat resistant polymer, resulting in poor density (low), and poor spreadability. When this occurs, even resins with relatively low viscosity have undergone reduced impregnation; thereby leading to low mechanical properties. In addition from an environmental standpoint, if the sizing amount is above 0.30 weight %, the possibility that harmful volatiles are generated becomes higher during the sizing application process.

In order for the preform, the semi-molded material and the molded material to have effective resin impregnation, a carbon fiber should have good drapeability. A drapeability of a carbon fiber (measured by the procedures described below) can be defined as drape value having less than 15 cm, 12 cm or less is better, 10 cm or less is even more desirable, 8 cm or less is most desirable.

The desirable relation B/A is greater than 1.05, and more desirable relation B/A is greater than 1.1, where A is the Interfacial Shear Strength (IFSS) of unsized fiber and B is IFSS of sized fiber in the present invention whose surface treatment must be same as the unsized fiber. IFSS can be measured by the Single Fiber Fragmentation Test (SFFT), and unsized fiber could be de-sized fiber. A SFFT procedure and a de-sizing method will be described later.

Sizing application process as a part of carbon fiber manufacturing is preferred to post application or “oversizing” of carbon fiber which can increase fuzz generation and cause contamination.

As for the thermoplastic resin fiber as matrix resin, most heat resistant resins could be used and the length is desirably 10 mm to 100 mm, more desirably 20 mm to 80 mm. The invention is not limited to any particular heat resistant thermoplastic resins, and a thermoplastic polyimide resin, a polyamideimide resin, a polyetherimide resin, a polysulfone resin, a polyethersulfone resin, a polyetheretherketone resin, a polyetherketoneketone resin, a polyamide resin and a polyphenylenesulfide resin may be used. And amorphous resin fiber, crystal resin fiber, and the mixture of the resin fibers can be also used. Especially, a preform including amorphous resin fibers can be fabricated into a semi-molded material at lower temperature and a molded material faster than those including crystal resin fibers

A heat resistant polymer is a desirable sizing agent to be used for sizing the carbon fiber. The sizing agents include a phenol resin, a urea resin, a melamine resin, a polysulfone resin, a polyethersulfone resin, a polyetheretherketone resin, a polyetherketoneketone resin, a polyphenylenesulfide resin, a polyimide resin, a polyamideimide resin, a polyetherimide resin, a polyamide and others. For some types of sizings, when the heat resistant polymer or polymer precursor is reacted chemically in order to obtain heat resistant polymer sizing on a carbon fiber, water could be generated by a condensation or addition reaction. For these sizings, it is desirable to complete the reaction in the process of the sizing application. Otherwise, voids in a composite could become a problem due to evolution of reaction product. An example of a heat resistant polymer is described below.

A polyimide is made by heat reaction or chemical reaction of polyamic acid. During the imidization process, water is generated; therefore, it is important to complete imidization before composite fabrication. A water generation ratio W based on a carbon fiber during a composite fabrication process is preferably 0.05 weight % or less. 0.03 weight % or less is desirable. Ideally, 0.01 weight % or less is optimal. The water generation ratio W can be defined by the following equation:

W(weight %)=B/A×100

where the weight A of a sized fiber is measured after holding 2 hours at 110 degrees Celsius and the weight difference B between 130 degrees Celsius and 415 degrees Celsius of a sized fiber is measured under air atmosphere with TGA (holding 110 degrees Celsius for 2 hours, then heating up to 450 degrees Celsius at 10 degrees Celsius/min).

An imidization ratio X of 80% or higher is acceptable, and 90% or higher is desirable. Ideally, 95% or higher is optimal. The imidization ratio X is defined by the following equation:

X(%)=(1−D/C)×100

where the weight loss ratio C of a polyamic acid without being imidized and the weight loss ratio D of a polyimide are measured between 130 degrees Celsius and 415 degrees Celsius under air atmosphere with TGA (holding 110 degrees Celsius for 2 hours, then heating up to 450 degrees Celsius at 10 degrees Celsius/minute).

The heat resistant polymer is preferably used in a form of an organic solvent solution, a water solution, a water dispersion or a water emulsion of the polymer itself or a polymer precursor. A polyamic acid which is the precursor to a polyimide is enabled to be water soluble by neutralization with alkali. It is preferred for the alkali to be water soluble. Chemicals such as ammonia, a monoalkyl amine, a dialkyl amine, a trialkyl amine, and tetraalkylammonium hydroxide could be used.

Organic solvents such as DMF (dimethylformamide), DMAc (dimethylacetamide), DMSO (dimethylsulfoxide), NMP (N-methylpyrrolidone), THF (tetrahydrofuran), etc. could be used. Naturally, low boiling point and safe solvents should be selected. It is desirable that the sizing agent is dried and sometimes reacted chemically in low oxygen concentration air or inert atmosphere such as nitrogen to avoid forming explosive mixed gas.

### <Fabrication Method of a Thermoplastic Molding Preform>

Thermoplastic molding preform can be obtained by conventional methods. For instance, two common methods are a wet method, in which short carbon fibers are stacked in water, and a dry method, where carbon fiber and resin filaments are intermingled in a carding process. And needle punching can be used to improve the out-of-plane strength of the preform(s).

### <Glass Transition Temperature>

The sizing has a glass transition temperature above 100 degrees Celsius. Above 150 degrees Celsius is better. Even more preferably the glass transition temperature shall be above 200 degrees Celsius.

A glass transition temperature is measured according to ASTM E1640 Standard Test Method for “Assignment of the Glass Transition Temperature by Dynamic Mechanical Analysis” using a Differential Scanning calorimetry (DSC).

### <Degree of Crystallinity>

A degree of crystallinity for thermoplastic resin fibers is preferably less than 70%, more preferably less than 50%.

When the degree of crystallinity is measured, first, the preform with a weight of about 5 mg is weighed and placed on a DSC under nitrogen atmosphere. The neat resin used for the preform can be also measured. The sample is analyzed at a heating ratio of 10 degrees Celsius/minute under a nitrogen flow of 50 ml/minute. The thermal history is from about 20 degrees Celsius to a temperature 20 degrees Celsius higher than the melting temperature. A degree of crystallinity K (%) can be estimated according to the following equation. Here L (J/g) is heat of crystallization, and M (J/g) is heat of fusion.

$$K ( \% ) = \frac{L + M}{M} \times 100$$

### <Thermal Degradation Onset Temperature>

A thermal degradation onset temperature of a sized fiber is preferably above 300 degrees Celsius. 370 degrees Celsius or higher is more desirable, 450 degrees Celsius or higher is most desirable. When a thermal degradation onset temperature is measured, first, a sample with a weight of about 5 mg is dried in an oven at 110 degrees Celsius for 2 hours, and cooled down to room temperature. Then it is weighed and placed on a thermogravimetric analyzer (TGA) under air atmosphere. Then, the sample is analyzed under an air flow of 60 ml/minute at a heating ratio of 10 degrees Celsius/minute. A weight change is measured between room temperature and 600 degrees Celsius. The degradation onset temperature of a sized fiber is defined as a temperature at which an onset of a major weight loss occurs. From the TGA experimental data, the sample weight, expressed as a percentage of the initial weight, is plotted as a function of the temperature (abscissa). By drawing tangents on a curve, the thermal degradation onset temperature is defined as an intersection point where tangent at a steepest weight loss crosses a tangent at minimum gradient weight loss adjacent to the steepest weight loss on a lower temperature side.

The definition of a thermal degradation onset temperature applies to the state of a carbon fiber after the chemical reaction but before a resin impregnation. The heat resistant property is imparted to the sized fiber by a chemical reaction affected before fiber is impregnated with resin.

If it is difficult to measure a thermal degradation onset temperature of a sized fiber, the sizing can be used in place of a sized fiber.

### <30% Weight Reduction Temperature>

30% weight reduction temperature of a sizing is preferably higher than 350 degrees Celsius. 420 degrees Celsius or higher is more desirable. 500 degrees Celsius or higher is most desirable. When a 30% weight reduction temperature is measured, first, a sample with a weight of about 5 mg is dried in an oven at 110 degrees Celsius for 2 hours, and cooled down to room temperature. Then it is weighed and placed on a thermogravimetric analyzer (TGA) under air atmosphere. Then, the sample is analyzed under an air flow of 60 ml/minute at a heating ratio of 10 degrees Celsius/minute. A weight change is measured between room temperature and 600 degrees Celsius. From the TGA experimental data, the sample weight, expressed as a percentage of the initial weight, is plotted as a function of the temperature (abscissa). The 30% weight reduction temperature of the sizing is defined as a temperature at which the weight of the sizing reduces by 30% with reference to the weight of the said sizing at 130 degrees Celsius.

### <Sizing Agent Application Method>

A sizing agent application method includes a roller sizing method, a submerged roller sizing method and/or a spray sizing method. The submerged roller sizing method is desirable because it is possible to apply a sizing agent very evenly even to large filament count tow fibers. Sufficiently spread carbon fibers are submerged in the sizing agent. In this process, a number of factors become important such as a sizing agent concentration, temperature, fiber tension, etc. for the carbon fiber to attain the optimal sizing amount for the ultimate objective to be realized. Often, ultrasonic agitation is applied to vibrate carbon fiber during the sizing process for better end result.

In order to achieve a sizing amount 0.05 to 0.30 weight % on the carbon fiber, the sizing concentration in the bath is preferably 0.05 to 2.0 weight %, more preferably 0.1 to 1.0 weight %.

### <Drying Treatment>

After the sizing application process, the carbon fiber goes through the drying treatment process in which water and/or organic solvent will be dried, which are solvent or dispersion media. Normally an air dryer is used and the dryer is run for 6 seconds to 15 minutes. The dry temperature should be set at 200 degrees Celsius to 450 degrees Celsius, 240 degrees Celsius to 410 degrees Celsius would be more ideal, 260 degrees Celsius to 370 degrees Celsius would be even more ideal, and 280 degrees Celsius to 330 degrees Celsius would be most desirable.

In case of thermoplastic dispersion, it is desirable that it should be dried at over the formed or softened temperature. This could also serve a purpose of reacting to the desired polymer characteristics. For this invention, the heat treatment will possibly be used with a higher temperature than the temperature used for the drying treatment. The atmosphere to be used for the drying treatment should be air; however, when an organic solvent is used in the process, an inert atmosphere involving elements such as nitrogen could be used.

### <Winding Process>

The carbon fiber tow, then, is wound onto a bobbin. The carbon fiber produced as described above is evenly sized. This helps make desired carbon fiber reinforced composite materials when mixed with the resin.

### EXAMPLES

Examples of a thermoplastic molding preform are explained next. The following methods are used for evaluating properties of the molding preform and a carbon fiber.

### <Sizing Amount>

Sizing amount in this invention is defined as the higher of the values obtained by the following two methods outlined below, and is considered to represent a reasonably true estimate of the actual amount of sizing on the fiber.

If a carbon fiber in itself cannot be obtained, a carbon fiber in a molding preform, a semi-molded material or a molded material can be used by removing the matrix resin with a solvent and so on. After the fiber is rinsed, the sizing amount can be measured according to the following two methods.

### (Alkaline Method)

Sizing amount (weight %) is measured by the following method.

(1) About 5 g carbon fiber is taken.
(2) The sample is placed in an oven at 110 degrees Celsius for 1 hour.
(3) It is then placed in a desiccator to be cooled down to the ambient temperature (room temperature).
(4) A weight W₀ is weighed.
(5) For removing the sizing by alkaline degradation, it is put in 5% KOH solution at 80 degrees Celsius for 4 hours.
(6) The de-sized sample is rinsed with enough water and placed in an oven for 1 hour at 110 degrees Celsius.
(7) It is placed in a desiccator to be cooled down to ambient temperature (room temperature).
(8) A weight W₁ is weighed.

The sizing amount (weight %) is calculated by the following formula.

Sizing amount(weight %)=(W₀−W₁)/(W₀)×100

### (Burn Off Method)

The sizing amount (weight %) is measured by the following method.

(1) About 2 g carbon fiber is taken.
(2) The sample is placed in an oven at 110 degrees Celsius for 1 hour.
(3) It is then placed in a desiccator to be cooled down to ambient temperature (room temperature).
(4) A weight W₀ is weighed.
(5) For removing the sizing, it is placed in a furnace of nitrogen atmosphere at 450 degrees Celsius for 20 minutes, where the oxygen concentration is less than 7 weight %.
(6) The de-sized sample is placed in a nitrogen purged container for 1 hour.
(7) A weight W₁ is weighed.

The sizing amount (weight %) is calculated by the following formula.

Sizing amount(weight %)=(W₀−W₁)/(W₀)×100

### <Drape Value>

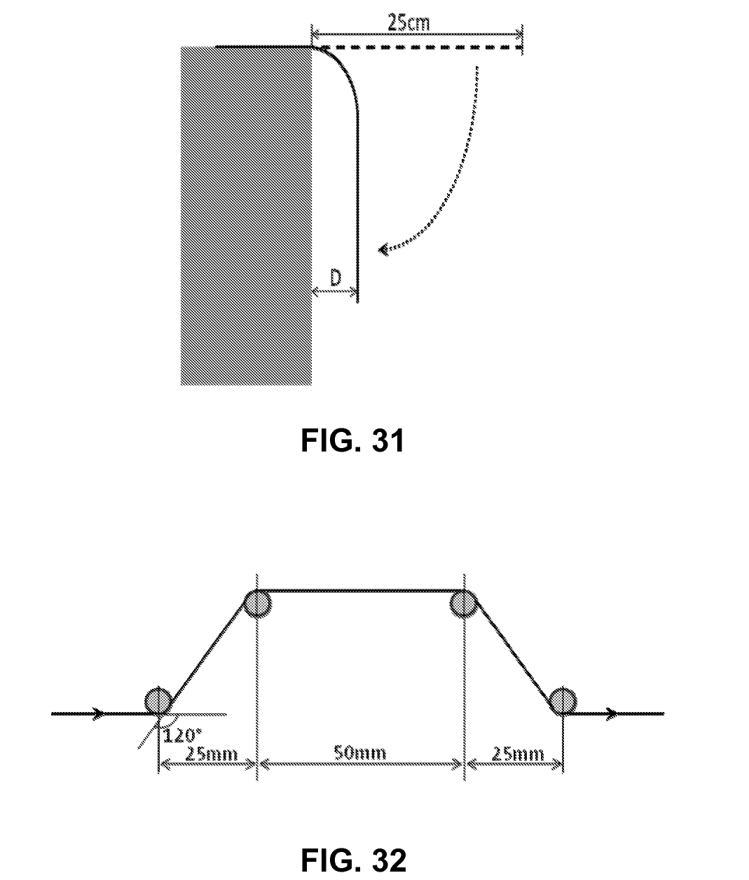

A carbon fiber tow is cut from the bobbin to a length of about 50 cm without applying any tension. A weight is attached on one end of the specimen after removing any twists and/or bends. The weight is 30 g for 12,000 filaments and 60 g for 24,000 filaments, so that 1 g tension is applied per 400 filaments. The specimen is then hung in a vertical position for 30 minutes with the weighted end hanging freely. After the weight is released from the specimen, the specimen is placed on a rectangular table such that a portion of the specimen is extended by 25 cm from an edge of the table having 90 degrees angle as shown in FIG. 31. The specimen on the table is fixed with an adhesive tape without breaking so that the portion hangs down from the edge of the table. A distance D (refer to FIG. 31) between a tip of the specimen and a side of the table is defined as the drape value.

### <Rubbing Fuzz Count>

As shown in FIG. 32, a carbon fiber tow is slid against four pins with a diameter of 10 mm (material: chromium steel, surface roughness: 1 to 1.5 μm RMS) at a speed of 3 meter/minute in order to generate fuzz. The initial tension to a carbon fiber is 500 g for the 12,000 filament strand and 650 g for 24,000 filament strand. The carbon fiber is slid against the pins by an angle of 120 degrees. The four pins are placed (horizontal distance) 25 mm, 50 mm and 25 mm apart (refer to FIG. 32). After the carbon fiber passes through the pins, fuzz blocks light incident on a photo electric tube from above, so that a fuzz counter counts the fuzz count.

### <Single Fiber Fragmentation Test (SFFT)>

Specimens are prepared with the following procedure.

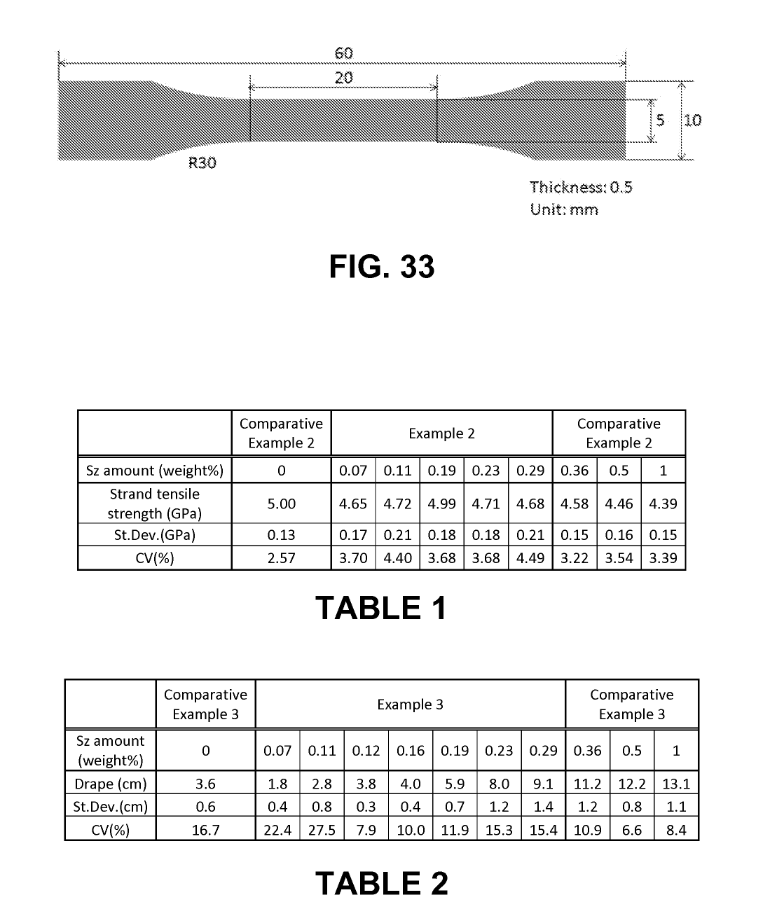

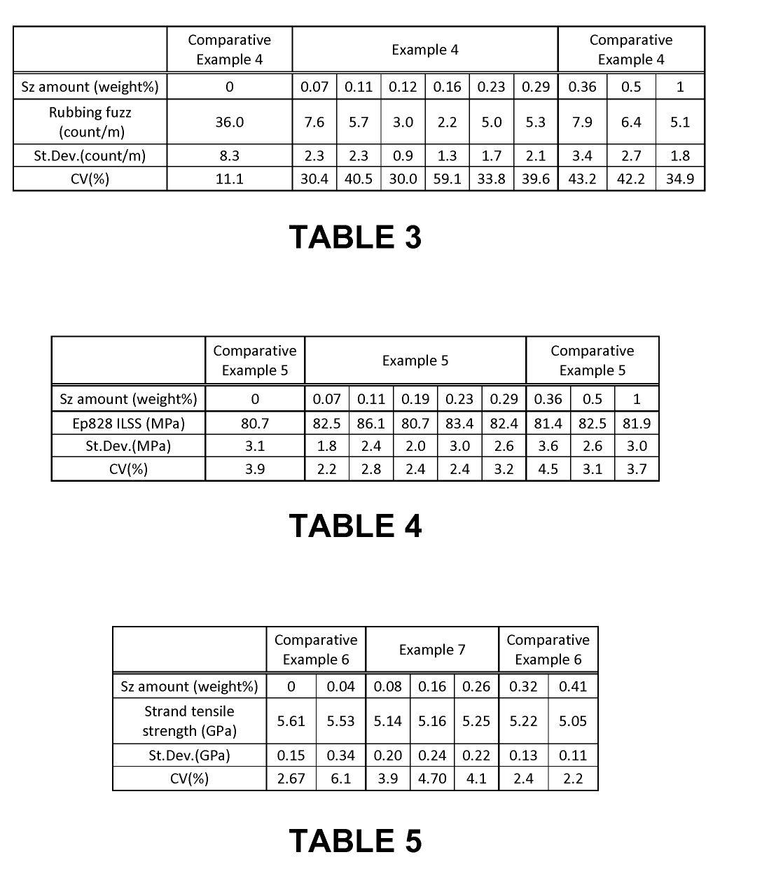

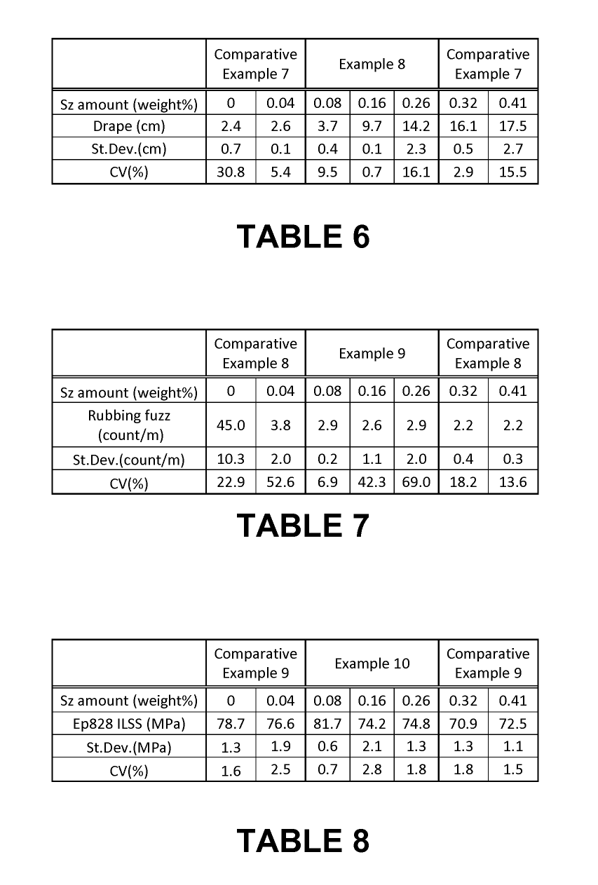

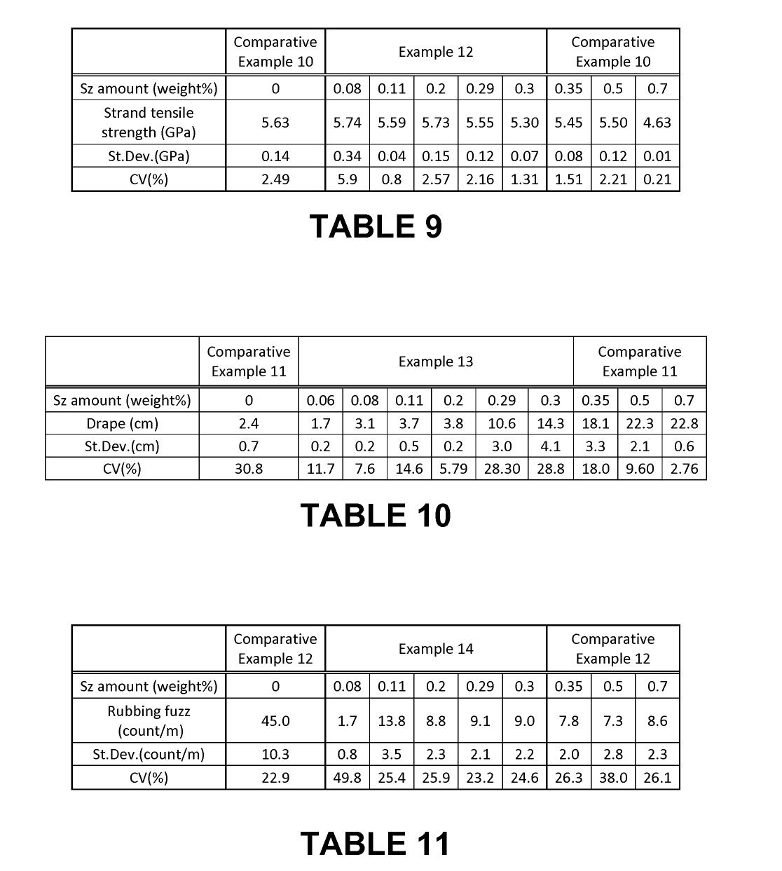

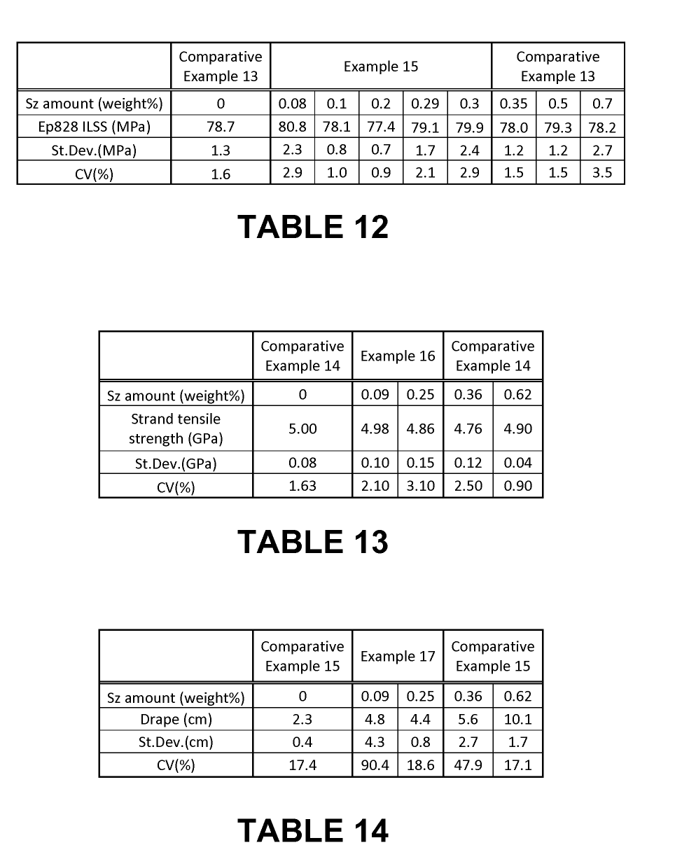

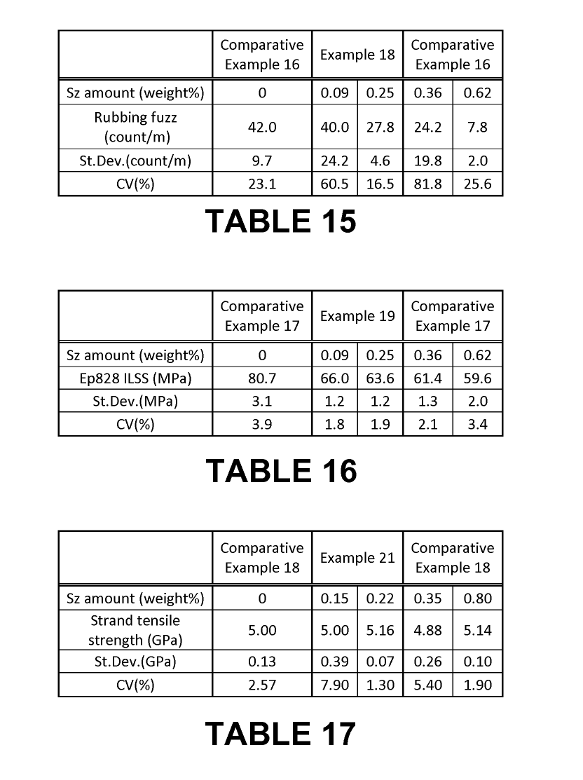

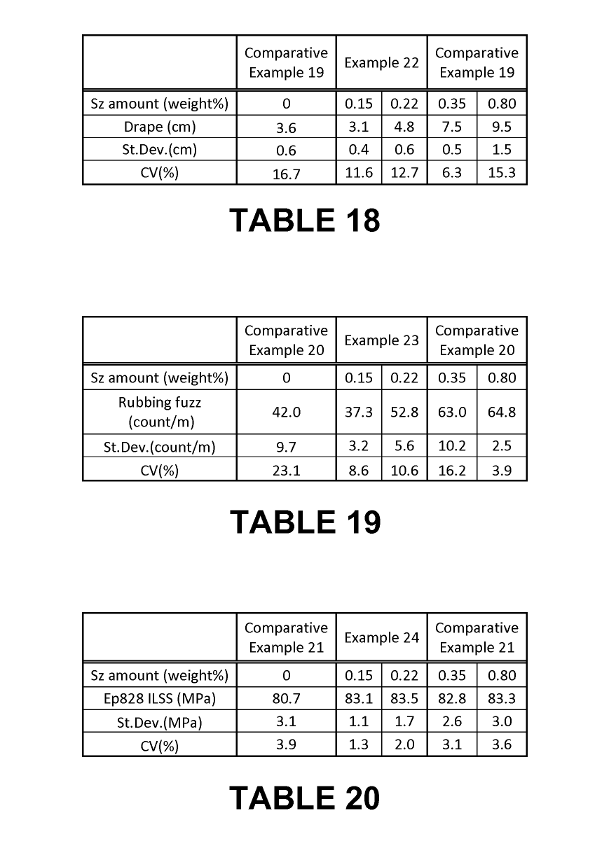

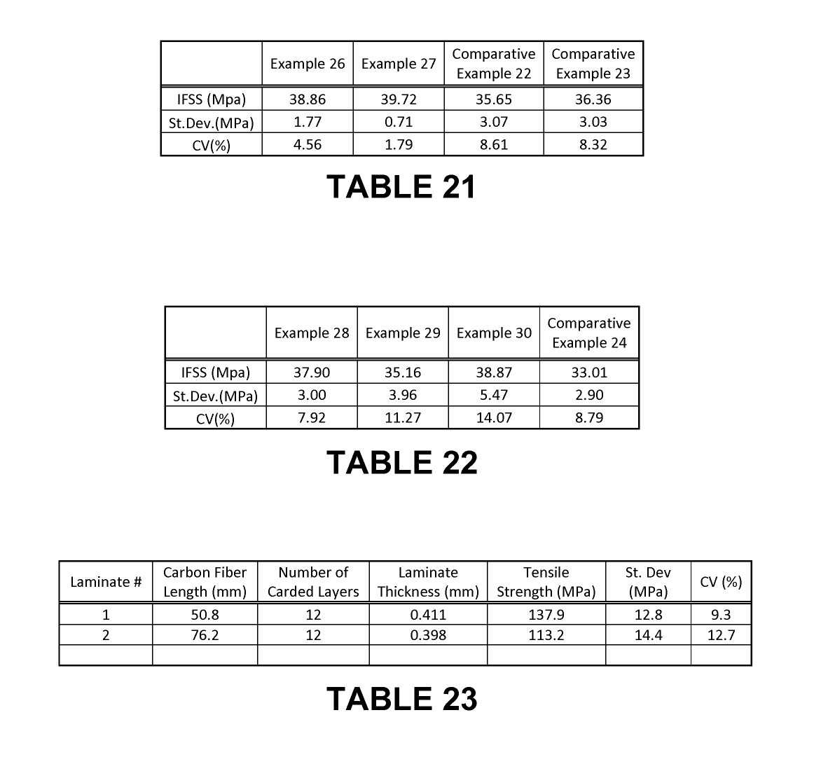

(1) Two aluminum plates (length: 250×width: 250×thickness: 6 (mm)), a KAPTON film (thickness: 0.1 (mm)), a KAPTON tape, a mold release agent, an ULTEM type polyetherimide resin sheet (thickness 0.26 (mm)), which must be dried in a vacuum oven at 110 degrees Celsius for at least 1 day, and carbon fiber strand are prepared.
(2) The KAPTON film (thickness: 0.1 (mm)) coated with a mold release agent is set on an aluminum plate.
(3) The ULTEM type polyetherimide resin sheet (length: 90×width: 150×thickness: 0.26 (mm)), whose grease on the surface is removed with acetone, is set on the KAPTON film.
(4) A single filament is picked up from the carbon fiber strand and set on the ULTEM type polyetherimide resin sheet.
(5) The filament is fixed at the both sides with a KAPTON tape to be kept straight.
(6) The filament (filaments) is overlapped with another ULTEM type polyetherimide resin sheet (length: 90×width: 150×thickness: 0.26 (mm)), and KAPTON film (thickness: 0.1 (mm)) coated with a mold release agent is overlapped on it.
(7) Spacers (thickness: 0.7 (mm)) are set between two aluminum plates.
(8) The aluminum plates including a sample are set on the pressing machine at 290 degrees Celsius.
(9) They are heated for 10 minutes contacting with the pressing machine at 0.1 MPa.
(10) They are pressed at 1 MPa and cooled at a speed of 15 degrees Celsius/minute being pressed at 1 MPa.
(11) They are taken out of the pressing machine when the temperature is below 180 degrees Celsius.
(12) A dumbbell shaped specimen, where a single filament is embedded in the center along the loading direction, has the center length 20 mm, the center width 5 mm and the thickness 0.5 mm as shown in FIG. 33.

SFFT is performed at an instantaneous strain rate of approximately 4%/minute counting the fragmented fiber number in the center 20 mm of the specimen at every 0.64% strain with a polarized microscope until the saturation of fragmented fiber number. The preferable number of specimens is more than 2 and Interfacial Shear Strength (IFSS) is obtained from the average length of the fragmented fibers at the saturation point of fragmented fiber number.

IFSS can be calculated from the equation below, where σ_{f} is the strand strength, d is the fiber diameter, L_{c} is the critical length (=4*L_{b}/3) and L_{b} is the average length of fragmented fibers.

$$IFSS = \frac{{σ}_{f} \cdot d}{2 {L}_{c}}$$

### <De-Sizing Process>

De-sized fiber may be used for SFFT in place of unsized fiber. De-sizing process is as follows.

(1) Sized fiber is placed in a furnace of nitrogen atmosphere at 500 degrees Celsius, where the oxygen concentration is less than 7 weight %.
(2) The fiber is kept in the furnace for 20 minutes.
(3) The de-sized fiber is cooled down to room temperature in nitrogen atmosphere for 1 hour.

### Example 1, Comparative Example 1

Carbon fibers sized with heat resistant sizing (The details will be described later) were chopped to lengths of 50.8 mm and 76.2 mm. Each fiber type/length was blended with amorphous PPS fibers with a degree of crystallinity of about 35%. The PPS fibers used were 5.5 denier and measured 50.8 mm in length. The target carbon fiber content (nominal) by weight was 20-25%. The carding process was performed on each blend using about 10 inch wide sample card to make a randomly-distributed fiber layer. Two layers of the carded material were stacked and then needlepunched to hold the layers together. The process resulted in two blends of carded, needlepunched material with carbon fiber areal weight of about 11 g/m² to be processed. (Example 1) Molding preform made of unsized fiber T700SC-12K could not be processed. (Comparative Example 1)

### Example 2-6, Comparative Example 2-5

A carbon fiber used for the above molding preform was fabricated as follows. Unsized 12K high tensile strength, standard modulus carbon fiber “Torayca” T700SC (Registered trademark by Toray Industries—strand strength 4.9 GPa, strand modulus 230 GPa) was continuously submerged in a sizing bath containing polyamic acid dimethylaminoethanol salt of 0.4 and 2.5 weight %. The polyamic acid is formed from the monomers 2,2′-Bis(4-(3,4-dicarboxyphenol)phenyl)propane dianhydride and meta-phenylene diamine. After the submerging process, it was dried at 300 degrees Celsius for 1 minute in order to have ULTEM type polyetherimide sizing. The sizing amount was about 0.2 weight % according to an alkaline method.

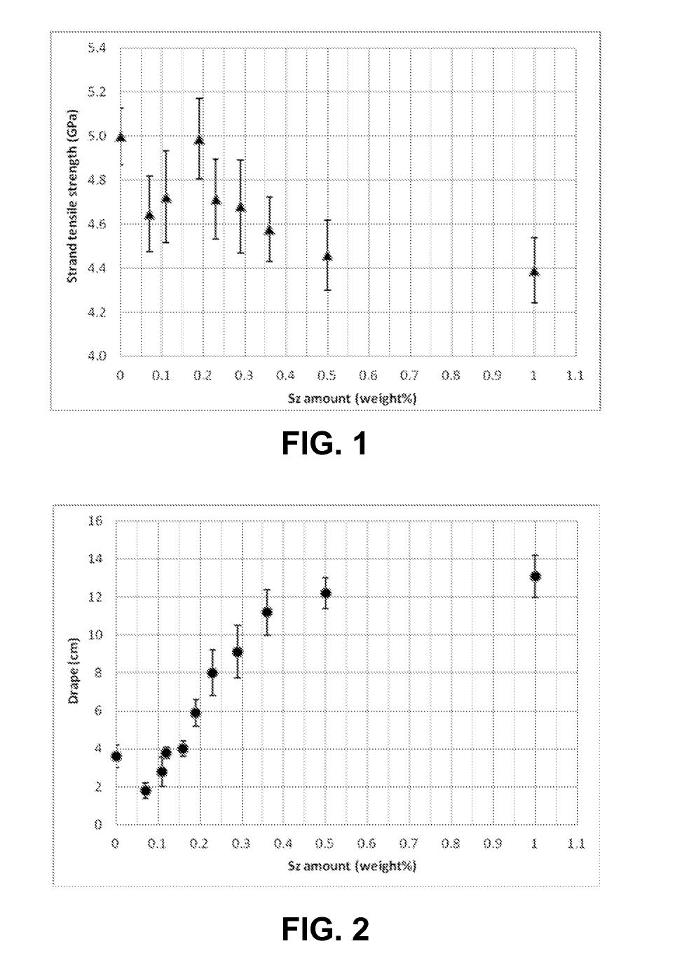

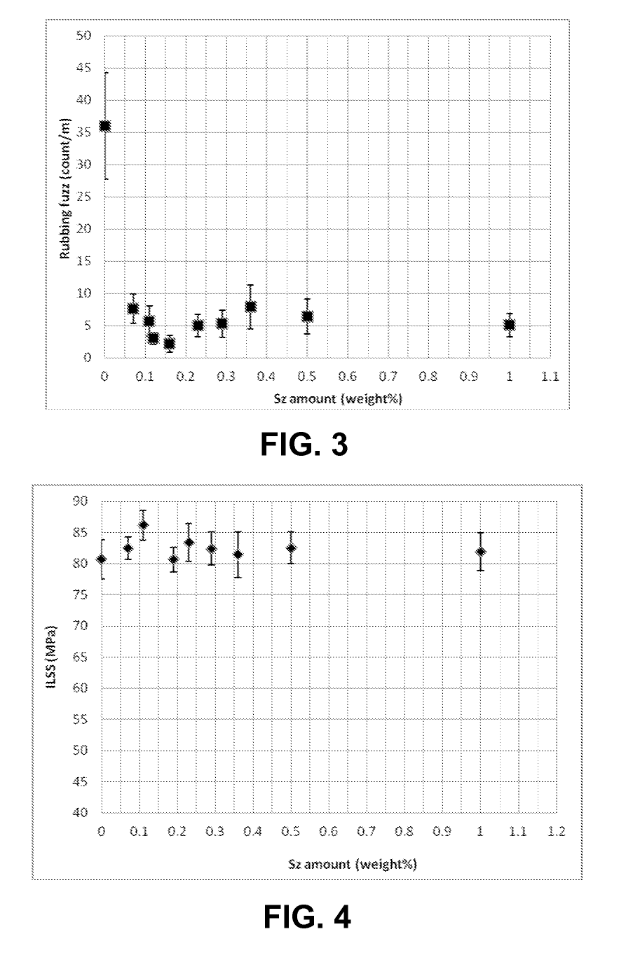

As same as above sizing application, a carbon fiber with different sizing amount was fabricated by submerging in the sizing bath containing polyamic acid dimethylaminoethanol salt of 0.1 to 2.0 weight %. And the tensile strengths, drape value, rubbing fuzz and ILSS of both the sizing amount of 0.05 to 0.30 weight % (Example 2-5) and 0.31 to 1.00 weight % (Comparative Example 2-5) were measured. The results are shown in Table 1-4 and FIGS. 1-4. The error bar in the figures indicates the standard deviation.

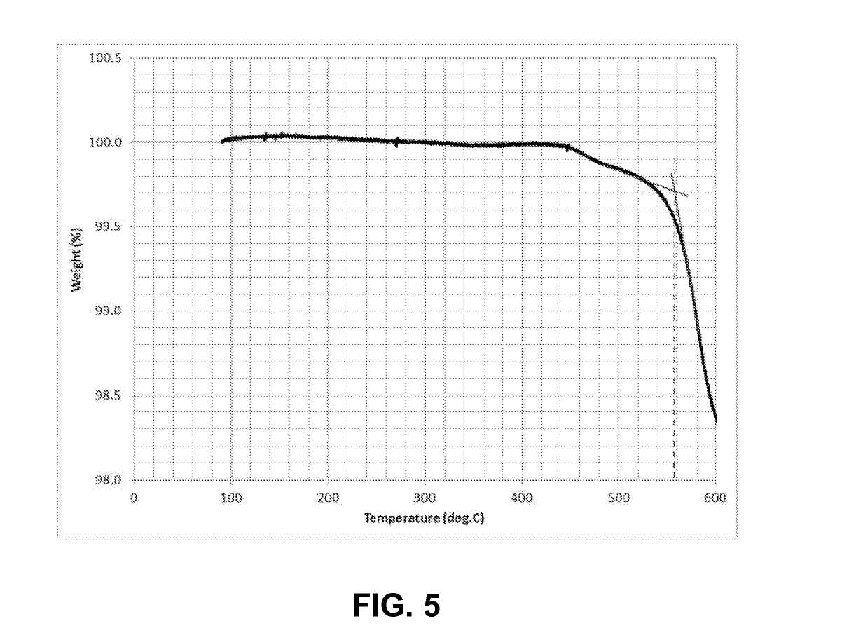

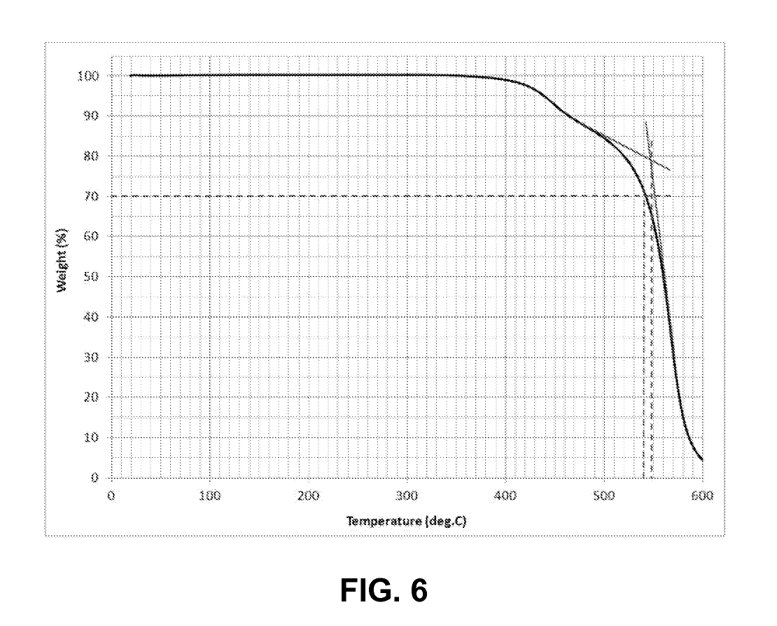

Thermogravimetric analysis (TGA) of the above sized fiber and sizing was conducted under air atmosphere. (Example 6) The heat degradation onset temperature of the sized fiber was 558 degrees Celsius as shown in FIG. 5. The heat degradation onset temperature of the sizing was 548 degrees Celsius and the 30% weight reduction temperature is 540 degrees Celsius as shown in FIG. 6, confirming the heat resistance is in excess of 500 degrees Celsius.

### Example 7-11, Comparative Example 6-9

Thermoplastic molding preform can be fabricated from KAPTON type polyimide coated carbon fiber according to the same procedure as Example 1, which is obtained from the following carbon fiber. Unsized 24K high tensile strength, intermediate modulus carbon fiber “Torayca” T800SC (Registered trademark by Toray Industries; strand strength 5.9 GPa, strand modulus 294 GPa) was used. The carbon fiber was continuously submerged in the sizing bath containing polyamic acid ammonium salt of 0.1 to 1.0 weight %. The polyamic acid is formed from the monomers pyromellitic dianyhydride and 4,4′-oxydiphenylene. After the submerging process, it was dried at 300 degrees Celsius for 1 minute in order to have poly(4,4′-oxydiphenylene-pyromellitimide) (KAPTON type polyimide) coating. The sizing amount was measured with an alkaline method.

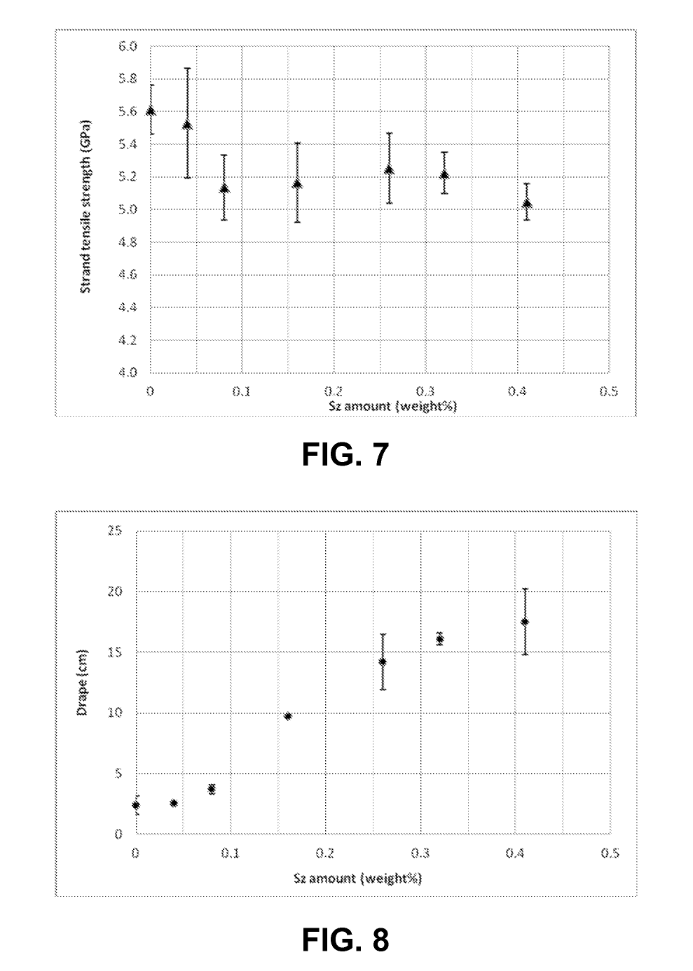

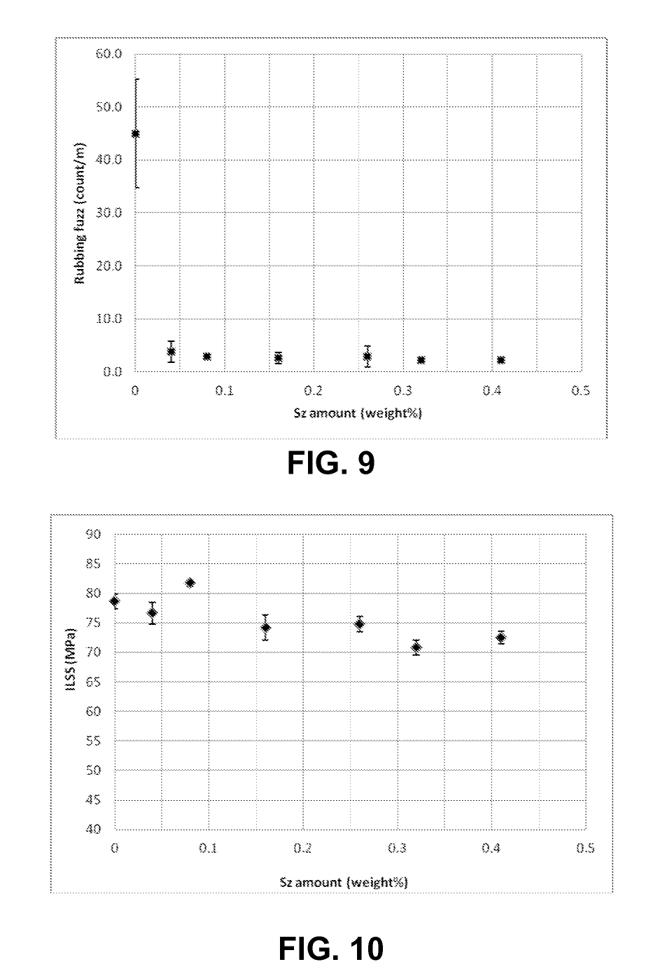

The tensile strengths, drape value, rubbing fuzz and ILSS of both the sizing amount of 0.05 to 0.30 weight % (Example 7-10) and 0.31 to 0.41 weight % (Comparative Example 6-9) were measured. The results are shown in Table 5-8 and FIGS. 7-10. The error bar in the figures indicates the standard deviation.

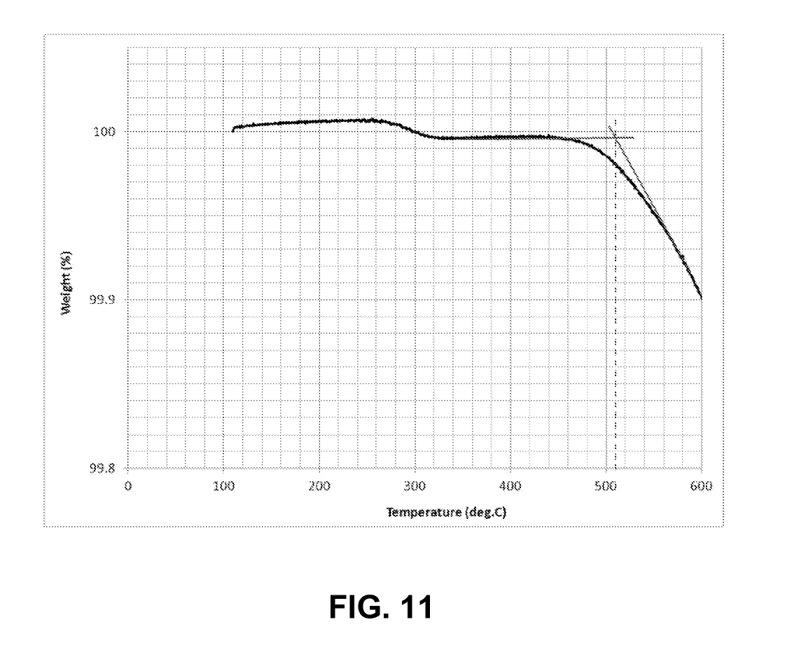

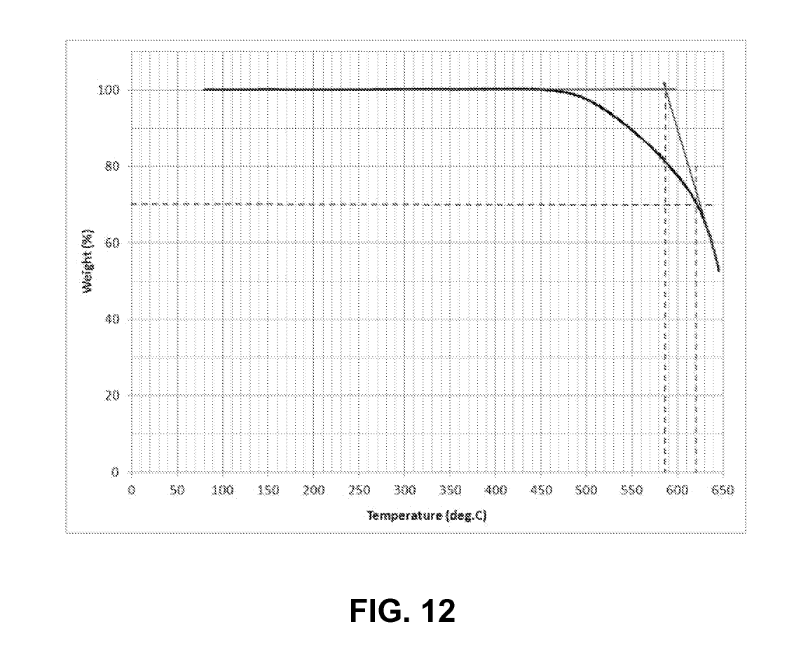

Thermogravimetric analysis (TGA) was conducted under air atmosphere. (Example 11) The heat degradation onset temperature of the same carbon fiber as the above is 510 degrees Celsius as shown in FIG. 11. The heat degradation onset temperature of the sizing of the sizing is 585 degrees Celsius and the 30% weight reduction temperature is 620 degrees Celsius as shown in FIG. 12, confirming the heat resistance is in excess of 500 degrees Celsius.

### Example 12-15, Comparative Example 10-13

Thermoplastic molding preform can be fabricated from ULTEM type polyetherimide coated carbon fiber according to the same procedure as Example 1, which is obtained from the following carbon fiber. Unsized 24K high tensile strength, intermediate modulus carbon fiber “Torayca” T800SC (Registered trademark by Toray Industries; strand strength 5.9 GPa, strand modulus 294 GPa) was used. The carbon fiber was continuously submerged in the sizing bath containing polyamic acid dimethylaminoethanol salt of 0.1 to 2.0 weight %. The polyamic acid is formed from the monomers 2,2′-Bis(4-(3,4-dicarboxyphenol)phenyl)propane dianhydride and meta-phenylene diamine. After the submerging process, it was dried at 300 degrees Celsius for 1 minute in order to have 2,2-Bis(4-(3,4-dicarboxyphenol)phenyl)propane dianhydride-m-phenylene diamine copolymer (ULTEM type polyetherimide) coating. The imidization ratio was 98%. The sizing amount was measured with an alkaline method.

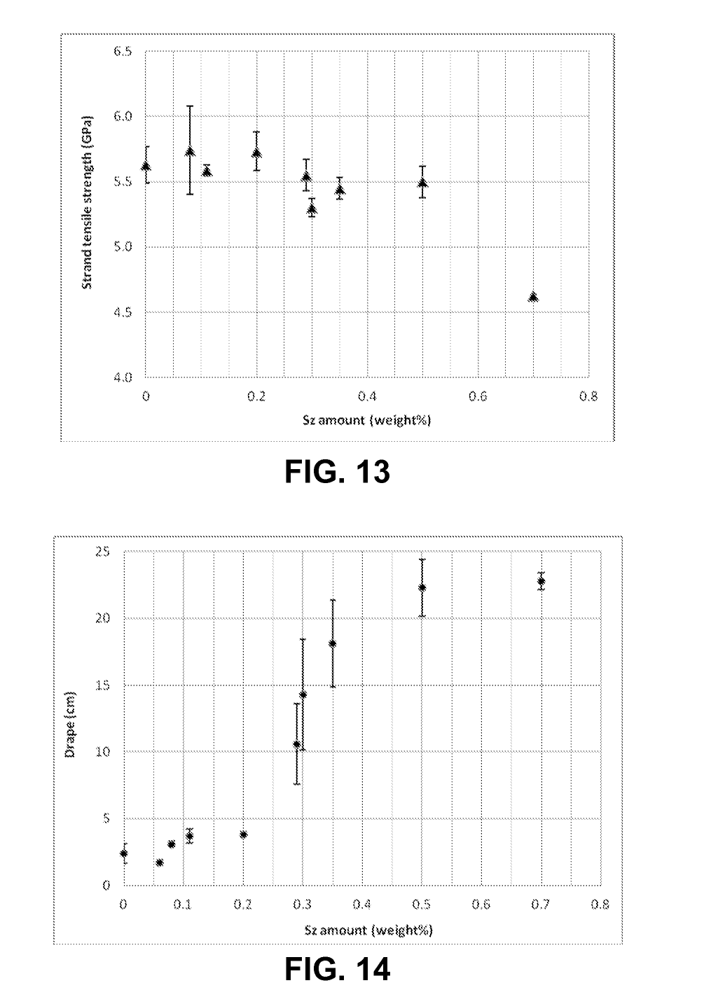

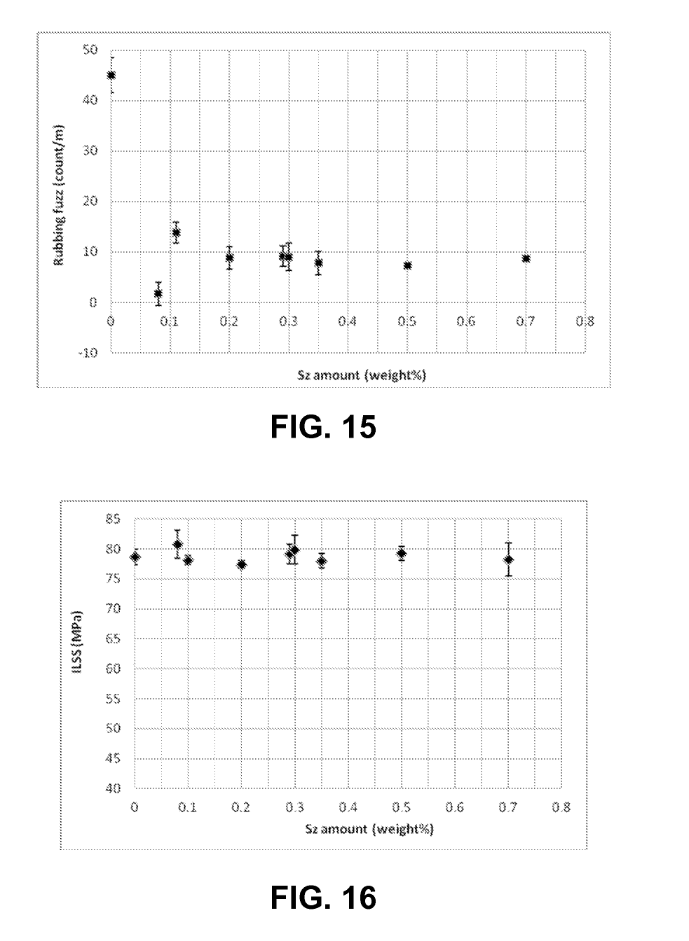

The tensile strengths, drape value, rubbing fuzz and ILSS of both the sizing amount of 0.05 to 0.30 weight % (Example 12-15) and 0.31 to 0.70 weight % (Comparative Example 10-13) were measured. The results are shown in Table 9-12 and FIGS. 13-16. The error bar in the figures indicates the standard deviation.

### Example 16-20, Comparative Example 14-17

Thermoplastic molding preform can be fabricated from Methylated melamine-formaldehyde coated carbon fiber according to the same procedure as Example 1, which is obtained from the following carbon fiber. Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing 0.2 to 1.6 weight % of methylated melamine-formaldehyde resin. After the submerging process, it was dried at 220 degrees Celsius for 1 minute. The sizing amount was measured with a burn off method.

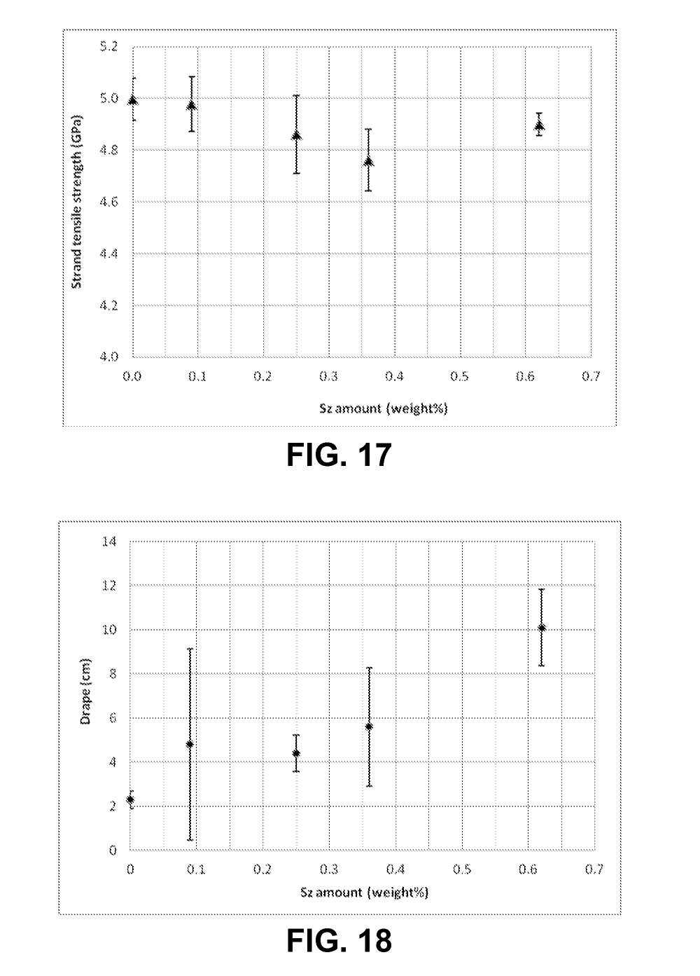

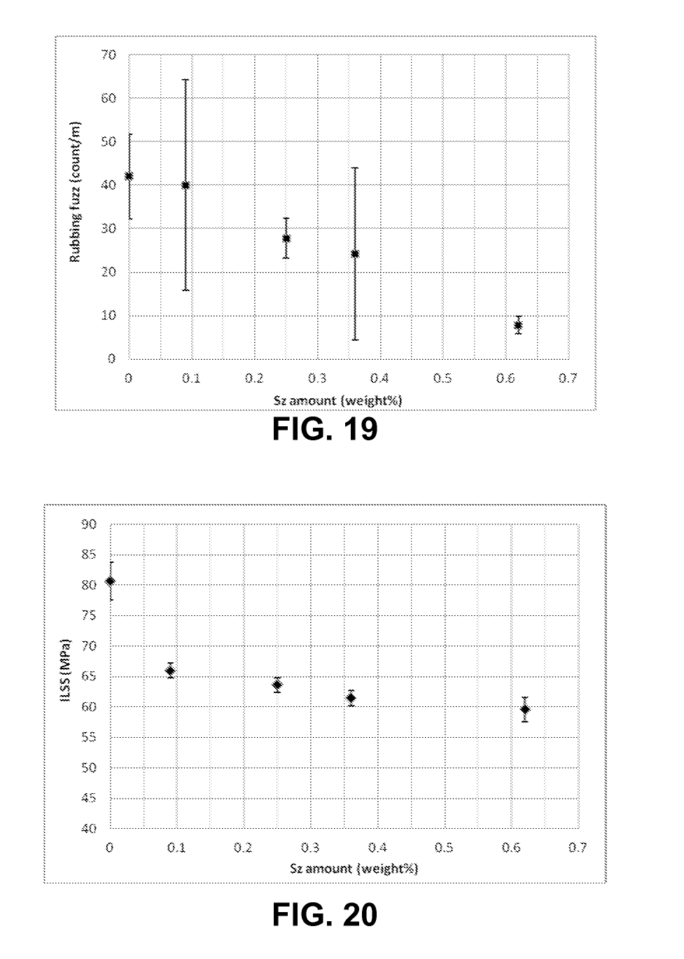

The tensile strengths, drape value, rubbing fuzz and ILSS of both the sizing amount of 0.05 to 0.30 weight % (Example 16-19) and 0.31 to 0.62 weight % (Comparative Example 14-17) were measured. The results are shown in Table 13-16 and FIGS. 17-20. The error bar in the figures indicates the standard deviation.

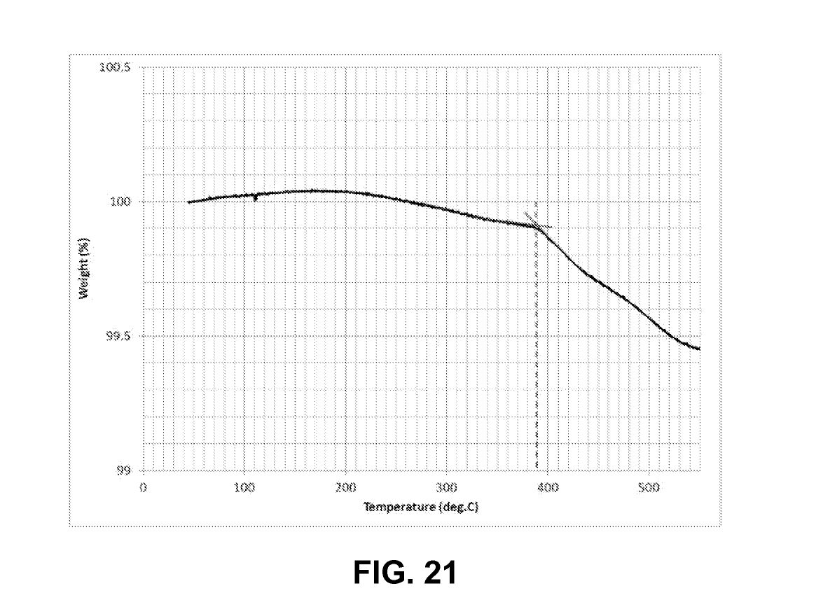

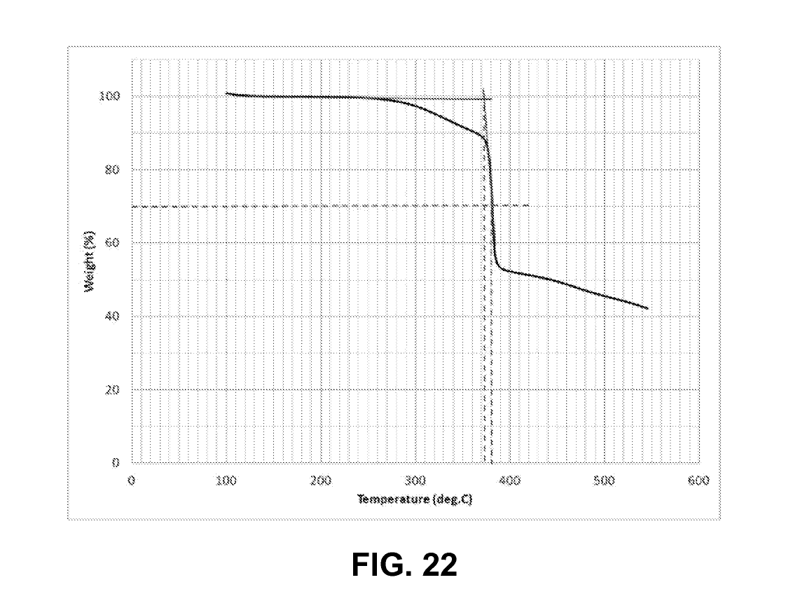

Thermogravimetric analysis (TGA) was conducted under air atmosphere. (Example 20) The heat degradation onset temperature of the same carbon fiber as the above is 390 degrees Celsius as shown in FIG. 21. The heat degradation onset temperature of the sizing is 375 degrees Celsius and the 30% weight reduction temperature is 380 degrees Celsius as shown in FIG. 22, confirming the heat resistance is in excess of 350 degrees Celsius.

### Example 21-25, Comparative Example 18-21

Thermoplastic molding preform can be fabricated from Epoxy cresol novolac coated carbon fiber according to the same procedure as Example 1, which is obtained from the following carbon fiber. Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing 0.1 to 2.0 weight % of epoxy cresol novolac resin. After the submerging process, it was dried at 220 degrees Celsius for 1 minute. The sizing amount was measured with a burn off method.

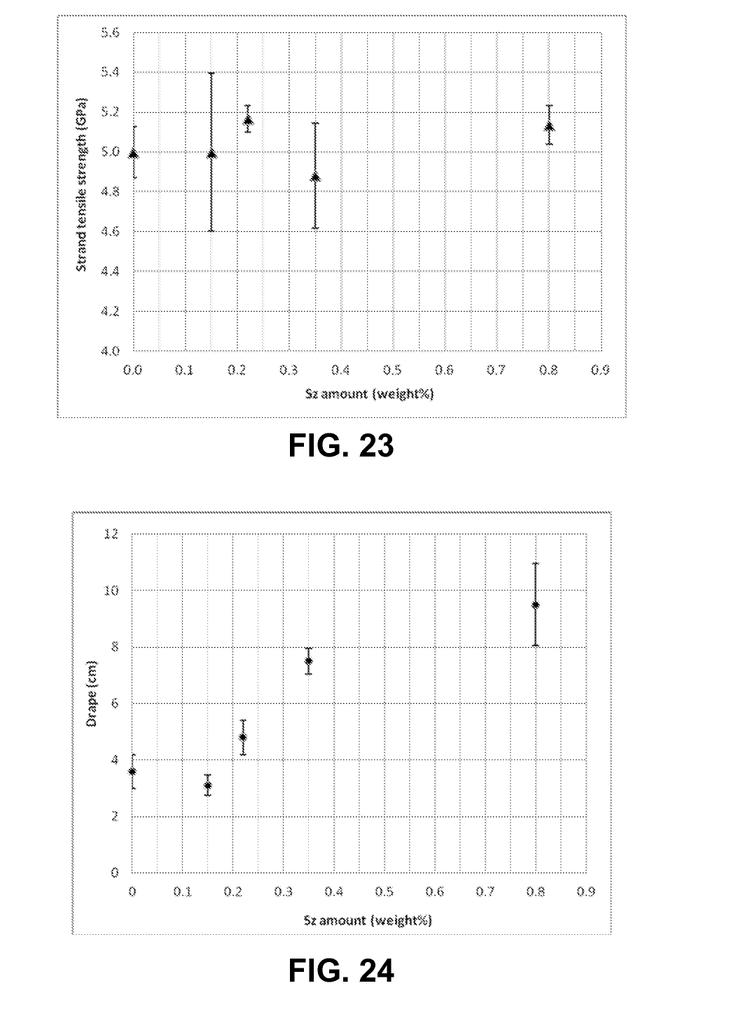

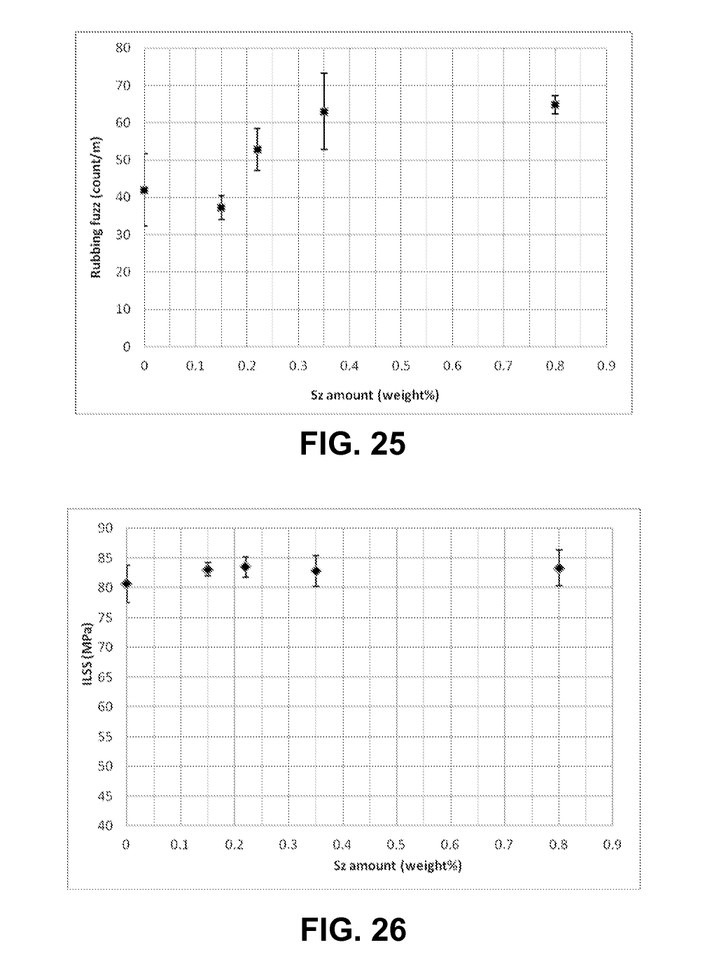

The tensile strengths, drape value, rubbing fuzz and ILSS of both the sizing amount of 0.05 to 0.30 weight % (Example 21-24) and 0.31 to 0.80 weight % (Comparative Example 18-21) were measured. The results are shown in Table 17-20 and FIGS. 23-26. The error bar in the figures indicates the standard deviation.

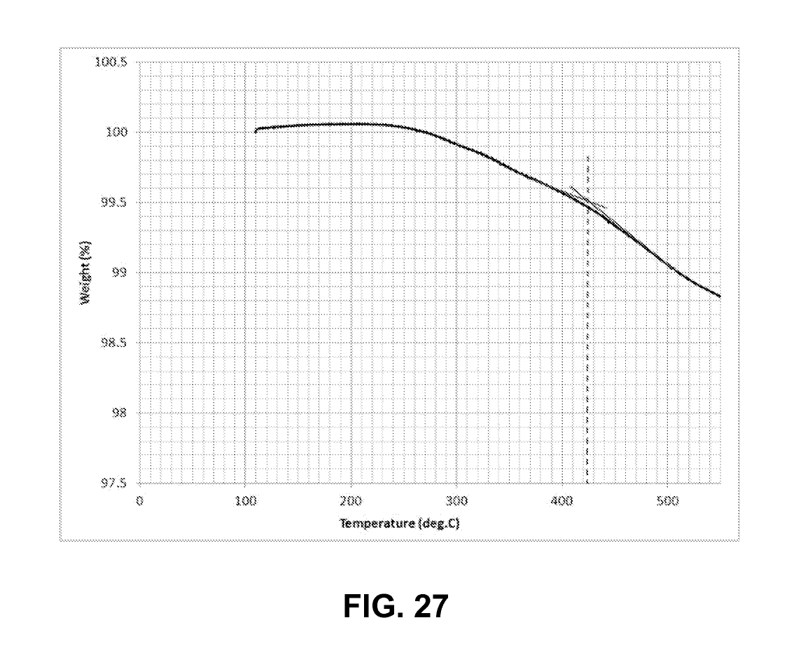

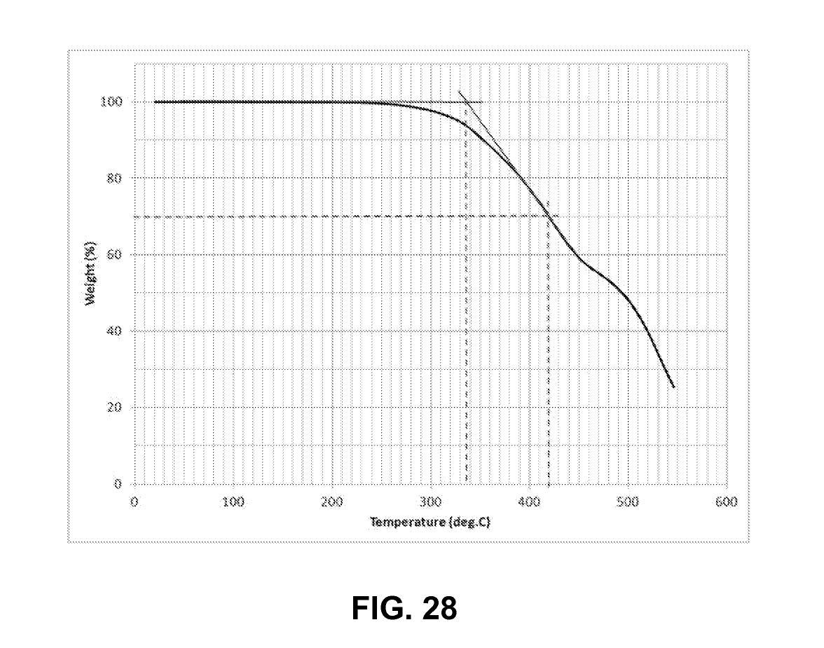

Thermogravimetric analysis (TGA) was conducted under air atmosphere. (Example 25) The heat degradation onset temperature of the same carbon fiber as the above is 423 degrees Celsius as shown in FIG. 27. The heat degradation onset temperature of the sizing is 335 degrees Celsius and the 30% weight reduction temperature is 420 degrees Celsius as shown in FIG. 28, confirming the heat resistance is in excess of 300 degrees Celsius.

### Example 26, 27, Comparative Example 22, 23

As indicated in Examples 7 and 12 the carbon fiber with about 0.2 weight % heat resistant sizing (Example 26, 27), “Torayca” T800SC-24K-10E and Unsized fiber T800SC-24K (Comparative Examples 22, 23) were used.

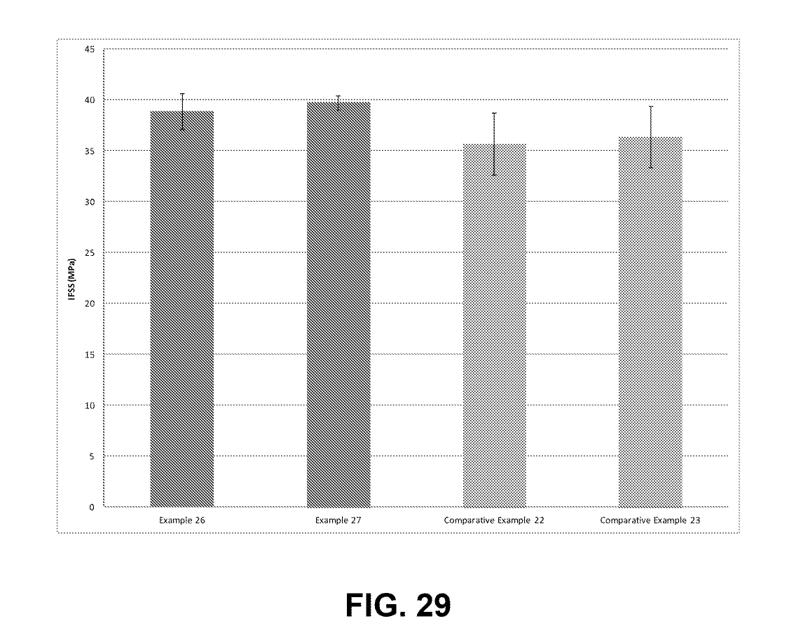

FIG. 29 and Table 21 show the results of SFFT using polyetherimide resin. From the results, it can be shown the IFSS of Example 26 and 27 are over 5% higher than that of Comparative Example 22 and 23.

### Example 28, 29, 30, Comparative Example 24

As indicated in Examples 2, 16 and 21, the carbon fiber with about 0.2 weight % heat resistant sizing (Examples 28, 29, 30) and Unsized fiber T700SC-12K (Comparative Example 24) were used.

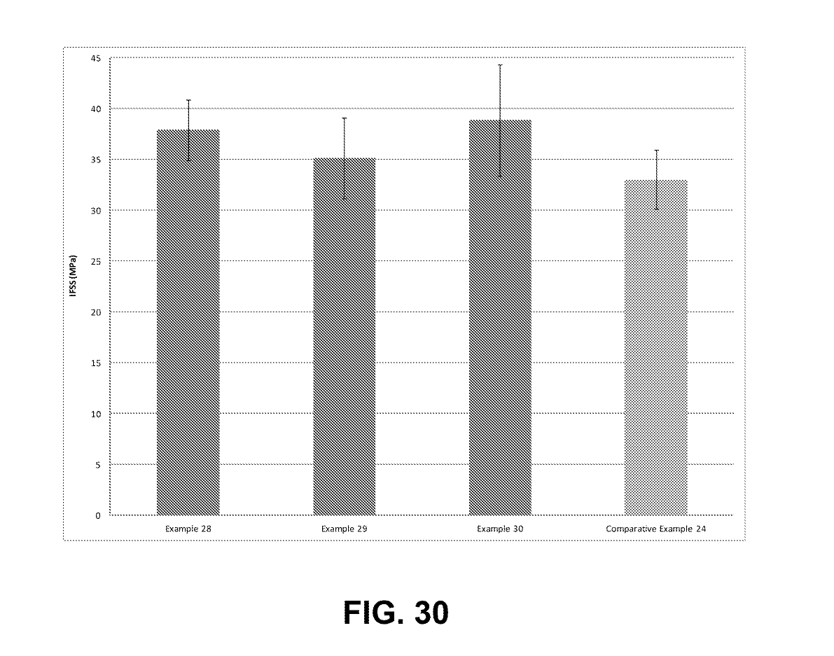

FIG. 30 and Table 22 show the results of SFFT using polyetherimide resin. It can be shown the IFSS of Example 28 through 30 are over 5% higher than that of Comparative Example 24 and the IFSS of Example 28 and 30 are over 10% higher than that of Comparative Example 24.

### Example 31

Carded material layers stacked with molding preforms of Example 1 and 2-6, as described in Table 23, were placed in a die preheated to 120 degrees Celsius. A pressure of 6.9 MPa was applied for 10 minutes, which are suitable parameters for fabricating semi-impregnated molding materials.

### Example 32

The semi-molded material produced in Example 31 was remained under pressure of 6.9 MPa while the die was further heated to 303 degrees Celsius. The material was held at this temperature for 15 minutes before allowing the material to cool under pressure. The thickness of each laminate is listed in Table 23.

Tensile testing was performed with more than 3 specimens according to ASTM 3039, but specimens measuring 12.7 mm wide and 139.7 mm long for Laminate 1 and 2. The gage length is 88.9 mm for both laminates. The results are shown in Table 23, where laminates 1 and 2 correspond to carbon fiber lengths of 50.8 mm and 76.2 mm in the preform, respectively.

While the invention has been explained with reference to the specific embodiments of the invention, the explanation is illustrative and the invention is limited only by the appended claims.

What is claimed is:

1. A thermoplastic molding perform, comprising:
thermoplastic fibers; and
carbon fibers coated with a sizing at an amount X between 0.05 and 0.30 weight %, said sizing being formed of a heat resistant polymer or a precursor of the heat resistant polymer, said amount X being expressed with a following formula:
$$X = \frac{{W}_{0} - {W}_{1}}{{W}_{0}} \times 100$$
where W₀ is a weight of the carbon fiber with the sizing, and W₁ is a weight of the carbon fiber without the sizing.

2. The thermoplastic molding preform according to claim 1, wherein said carbon fibers have a ratio of 10% to 70% by volume relative to a total volume of the carbon fibers and the thermoplastic fibers.

3. The thermoplastic molding preform according to claim 1, wherein said carbon fibers have a length of 10 mm to 100 mm.

4. The thermoplastic molding preform according to claim 1, wherein said thermoplastic fibers have a length of 10 mm to 100 mm.

5. The thermoplastic molding preform according to claim 1, wherein said thermoplastic fibers are formed at least one of a thermoplastic polyimide resin, a polyamideimide resin, a polyetherimide resin, a polysulfone resin, a polyethersulfone resin, a polyetheretherketone resin, a polyetherketoneketone resin, a polyphenylenesulfide resin, and a polyamide resin.

6. The thermoplastic molding preform according to claim 1, wherein said thermoplastic fibers are formed of a resin having a degree of crystallinity less than 70%.

7. The thermoplastic molding preform according to claim 1, wherein said carbon fibers have an areal weight of 5 g/m² to 600 g/m².

8. A thermoplastic semi-molded material comprising the thermoplastic molding preform according to claim 1 so that a void content of the thermoplastic semi-molded material becomes between 10 and 80% by volume.

9. A thermoplastic molded material comprising the thermoplastic molding preform according to claim 1 so that a void content of the thermoplastic semi-molded material becomes less than 10% by volume.

10. The thermoplastic molding preform according to claim 1, wherein said heat resistant polymer on the carbon fibers has a thermal degradation onset temperature higher than 300 degrees Celsius.

11. The thermoplastic molding preform according to claim 1, wherein said heat resistant polymer on the carbon fibers has a thermal degradation onset temperature higher than 370 degrees Celsius.

12. The thermoplastic molding preform according to claim 1, wherein said heat resistant polymer on the carbon fibers has a thermal degradation onset temperature higher than 450 degrees Celsius.

13. The thermoplastic molding preform according to claim 1, wherein said heat resistant polymer on the carbon fibers has a 30% weight reduction temperature higher than 350 degrees Celsius.

14. The thermoplastic molding preform according to claim 1, wherein said heat resistant polymer on the carbon fibers has a 30% weight reduction temperature higher than 420 degrees Celsius.

15. The thermoplastic molding preform according to claim 1, wherein said heat resistant polymer on the carbon fibers has a 30% weight reduction temperature higher than 500 degrees Celsius.

16. The thermoplastic molding preform according to claim 1, wherein said carbon fibers have an interfacial shear strength A greater than an interfacial shear strength B of the carbon fibers without the sizing, said interfacial shear strengths A and B being measured with a single fiber fragmentation test.

17. The thermoplastic molding preform according to claim 16, wherein said carbon fibers have the interfacial shear strength A so that a relation of A/B≧1.05 is satisfied.

18. The thermoplastic molding preform according to claim 16, wherein said carbon fibers have the interfacial shear strength A so that a relation of A/B≧1.10 is satisfied.

19. The thermoplastic molding preform according to claim 1, wherein said heat resistant polymer or said precursor is applied to the carbon fibers in a form of an organic solution, an aqueous solution, an aqueous dispersion, or an aqueous emulsion.

20. The thermoplastic molding preform according to claim 1, wherein said carbon fibers are produced through a fabrication process including a carbonization process, a sizing application process, a drying process, and a continuous winding process.

21. The thermoplastic molding preform according to claim 1, wherein said carbon fibers are produced through a fabrication process including a drying process at a temperature higher than 200 degrees Celsius for longer than 6 seconds.

22. The thermoplastic molding preform according to claim 1, wherein said carbon fibers are produced through a fabrication process including a drying process at a temperature higher than 240 degrees Celsius for longer than 6 seconds.

23. The thermoplastic molding preform according to claim 1, wherein said carbon fibers are produced through a fabrication process including a drying process at a temperature higher than 280 degrees Celsius for longer than 6 seconds.

24. The thermoplastic molding preform according to claim 1, wherein said heat resistant polymer on the carbon fiber is at least one of a phenol resin, a melamine resin, a urea resin, a polyimide resin, a polyamideimide resin, a polyetherimide resin, a polysulfone resin, a polyethersulfone resin, a polyetheretherketone resin, a polyetherketoneketone resin, a polyamide resin, and a polyphenylenesulfide resin.

25. The thermoplastic molding preform according to claim 1, wherein said carbon fibers have a tensile modulus between 200 and 600 GPa.

26. The thermoplastic molding preform according to claim 1, wherein said carbon fibers have a tensile strength between 3.0 and 7.0 GPa.

27. The thermoplastic molding preform according to claim 1, wherein said carbon fibers have a drape value less than 15 cm.

28. The thermoplastic molding preform according to claim 1, wherein said carbon fibers are formed of filaments having a number between 1,000 and 48,000.
